(19) United States
(12) Patent Application Publication
(10) Pub. No.: US 2007/0294455 A1
(43) Pub. Date: Dec. 20, 2007

(54) Data Interface

(75) Inventors: Neil Buxton, Abingdon (GB); Mark David Bridger, Abingdon (GB); Mehrdad Nikfarjam Khodaparast, Abingdon (GB)

Correspondence Address: HARNESS, DICKEY & PIERCE, P.L.C., P.O. BOX 828, BLOOMFIELD HILLS, MI, 48303, US

(73) Assignee: OXFORD SEMICONDUCTOR LIMITED, Abingdon, Oxfordshire (GB)

(21) Appl. No.: 10/593,668

(22) PCT Filed: Mar. 21, 2005
(86) PCT No.: PCT/GB05/01068

§ 371 Date: May 1, 2007

(30) Foreign Application Priority Data
Mar. 22, 2004 (GB) 0406423.4

(51) Int. Cl. G06F 13/40; G06F 3/06

(52) U.S. Cl. 710/307

(57) ABSTRACT

In order provide a host apparatus 20, such as a digital television receiver, with the capability of transmitting commands to an external storage medium device 21 connected to the host apparatus 20 over an external databus 22, the host apparatus 20 is provided with: a command bus 28 and a command interface 26, 27 arranged in accordance with one of the ATA/IDE standard or the Serial ATA standard for transmitting commands to a storage medium device over the storage medium command bus 28; and an integrated circuit chip 29 connected to the command bus 28 and to the external databus 22 and having an interface arranged to convert commands received from the command bus 28 in a format in accordance with said one of the ATA/IDE standard or the Serial ATA standard into a format for the external databus 22 and to transmit the converted commands over the external databus 22. The external databus 22 may be arranged in accordance with the IEEE 1394 standard or the Universal Serial Bus standard. The storage medium device standard may be an Advanced Technology Attachment standard.

The present invention relates to providing a host apparatus, such as a digital television receiver apparatus (a “set-top box”), with the capability of transmitting commands to an external storage medium device, in order to record data on, and reproduce data from, the external storage medium device. The external storage medium is typically connected to the host apparatus by an external databus, for example arranged in accordance with the IEEE 1394 standard or the Universal Serial Bus standard.

Currently, to provide this capability, the host apparatus is provided with an interface for transmitting commands onto the external databus. However, the implementation of such an interface introduces a number of difficulties for the designer of the host apparatus. In particular, the interface to an external databus, such as an IEEE 1394 interface or a USB interface, requires extensive hardware and software. Therefore the interface needs considerable support from the firmware on the host apparatus, both in terms of the amount of code requiring development and the utilisation of the processor of the host apparatus. Thus, much design work is required and the resultant solution, due to its reliance on the processor of the host apparatus, may fail to meet performance targets or else require the processing capability of the host apparatus to be upgraded. Furthermore, the broader functionality of the interface to the external databus may in some cases be unnecessary for any other reason.

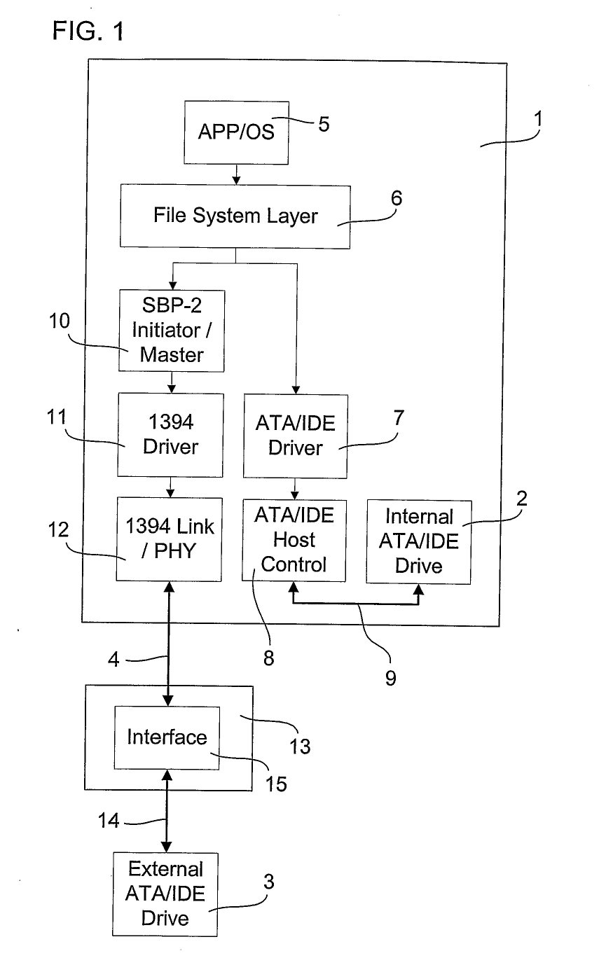

To illustrate these difficulties, FIG. 1 illustrates an example of such an implementation in a host apparatus 1. In particular, FIG. 1 shows the software stack and hardware layers required for access both to an internal disk drive 2 and to an external disk drive 3 connected over an external databus 4, in which the disk drives 2 and 3 are arranged in accordance with the ATA/IDE standard and the external databus is arranged in accordance with the IEEE 1394 standard. The implementation of FIG. 1 is typical of a PC/MAC solution.

For control of the internal drive 2, the host apparatus 1 has, under an application/operating system layer 5 and a file system layer 6, an ATA/IDE driver layer 7 controlling ATA/IDE host control logic 8. The ATA/IDE controller logic 8 is connected to the internal disk drive 2 via a physical ATA/IDE bus 9.

For control of the external drive 3, the host apparatus 1 has, under the file system layer 6, an interface for the external databus 4 in the form of an SBP-2 initiator/master software stack 10, below which is a 1394 driver 11 controlling the 1394 link/physical layer 12 which is the hardware connected to the external databus 4. The external disk drive 3 is connected to the external databus 4 by a bridge circuit 13. In particular, the external disk drive 3 is connected by an ATA/IDE bus 14 to the bridge circuit 13 which has an interface 15 for converting commands received from the host apparatus 1 via the external databus 4 from a format in accordance with the IEEE 1394 standard into a format in accordance with the ATA/IDE standard for supply over the ATA/IDE bus 14.

Thus, to add the capability of controlling the remote disk drive 3, the host apparatus 1 must implement the SBP-2 initiator/master software stack 10 and the 1394 driver 11. In addition to this software requirement, the host apparatus 1 needs to provide a hardware mechanism of access to the external databus 4. For this purpose, the 1394 link/physical layer 12 is typically implemented by a controller chip. Such chips typically provide support for 1394 transactions but not the SBP-2 protocol layer, and range in performance and complexity between OHCl (Open Host Controller Interface) chips and simple 1394 controllers. The bus interface of OHCl chips is commonly PCI, which is not often available in consumer electronic devices. Both OHCl and the simple controllers need considerable support from the firmware on the host apparatus, both in terms of the amount of code requiring development and the utilisation of the processor of the host apparatus. In other words, the host software for the external disk drive 3 is more complex than the host software for the internal disk drive 2, ie the ATA/IDE driver layer 7, and consequently the utilisation of the processor of the host apparatus 1 is significantly greater for the external disk drive 3 than for the internal disk drive 2.

It would be desirable to provide a host apparatus with the capability of transmitting commands to an external storage medium device in a manner which avoids these difficulties and is relatively straightforward to implement without placing a burden on the processor of the host apparatus.

According to one aspect of the present invention, there is provided a method of arranging a host apparatus to transmit commands to an external storage medium device connected to the host apparatus over an external databus which is arranged in accordance with one of the IEEE 1394 standard or the Universal Serial Bus standard, the method comprising:

providing the host apparatus with a command bus and a command interface arranged in accordance with one of the ATA/IDE standard or the Serial ATA standard for transmitting commands to a storage medium device over the storage medium command bus; and

providing the host apparatus with at least one integrated circuit chip connected to the command bus and to the external databus and having an interface arranged to convert commands received from the command bus in a format in accordance with said one of the ATA/IDE standard or the Serial ATA standard into a format in accordance with said one of the IEEE 1394 standard or the Universal Serial Bus standard and to transmit the converted commands over the external databus.

According to a further aspect of the present invention, there is provided a host apparatus arranged to transmit commands to an external storage medium device connected to the host apparatus over an external databus which is arranged in accordance with one of the IEEE 1394 standard or the Universal Serial Bus standard, the host apparatus comprising:

a command bus and a command interface arranged in accordance with one of the ATA/IDE standard or the Serial ATA standard for transmitting commands to a storage medium device over the storage medium command bus; and

at least one integrated circuit chip connected to the storage medium command bus and having terminals for connection to the external databus, the integrated circuit chip having an interface arranged to convert commands received from the command bus in a format in accordance with one of the ATA/IDE standard or the Serial ATA standard into a format in accordance with said one of the IEEE 1394 standard or the Universal Serial Bus standard, and to supply the converted commands to the terminals for connection to the external databus.

Therefore, the present invention makes use of a command interface arranged in accordance with one of the ATA/IDE standard or the Serial ATA standard which is a storage medium device standard suitable for transmitting commands to a storage medium device over a command bus, in combination with an integrated circuit chip(s) which converts commands received from the command bus in a format in accordance with said one of the ATA/IDE standard or the Serial ATA standard into a format appropriate for the external databus. The commands in accordance with the ATA/IDE standard or the Serial ATA standard include commands to record data on the storage medium and to reproduce data from the storage medium. Thus, the integrated circuit chip(s) effectively acts as a host device to send the commands over the external databus and hence to the external storage medium device. The remainder of the host apparatus need have no knowledge of the external databus. The external storage medium behaves as if it were local to the command interface on the host apparatus, even though it is in fact remotely connected over the external databus and hence achieves all the advantages associated with the use of such an external databus, for example having a small bus connector and allowing the use of any device compatible with the external databus.

From the point of view of the designer of the host apparatus, the invention makes it straightforward to incorporate the benefits of the storage medium device without the complexity incurred in the implementation of an interface to the external databus as described above, for example with reference to FIG. 1. This advantage is achieved by making use of a command interface in accordance with one of the ATA/IDE standard or the Serial ATA standard for transmitting commands to a storage medium device over a command bus. Such a command interface is intrinsically simple, but more importantly is of a type which is often already implemented in a host apparatus for controlling an internal disk drive. Thus, in implementing the command interface, both the utilisation of the processor of the host apparatus and the burden on the designer of the host apparatus is minimal, in terms of both the hardware and software used.

The use of the command interface, which is not in itself suitable to bring to an external connector on the host apparatus, is made possible by the integrated circuit chip(s). This is straightforward to implement as the integrated circuit chip(s) may simply be inserted into the host apparatus with minimal modification to the design of the host apparatus. The designer of the host apparatus can use an integrated circuit chip(s) from an external supplier or else design a custom integrated circuit chip(s) which would then be usable in a range of types of host apparatus. Importantly, the integrated circuit chip(s) does not place any burden on the main processor of the host apparatus in which it is included because it is implemented in an integrated circuit chip(s) which can operate independently of the main processor of the host apparatus. Thus the present invention does not limit the performance of the host apparatus.

In summary, benefits which can be achieved by embodiments of the present invention, as compared to the implementation of an interface to the external databus of the type shown in FIG. 1 include: ease of integration with current designs of host apparatus; a simpler hardware implementation; a simpler host software requirement and hence a reduced load on the processor of the host apparatus which can prevent loss of performance.

For simplicity, the present invention will normally be implemented by a single integrated circuit chip. Accordingly, in accordance with a further aspect of the present invention, there is provided an integrated circuit chip having:

terminals for connection to a command bus in accordance with one of the ATA/IDE standard or the Serial ATA standard for transmitting commands to a storage medium device over the storage medium command bus;

terminals for connection to an external databus in accordance with one of the IEEE 1394 standard or the Universal Serial Bus standard; and

an interface arranged to convert commands received at the terminals for connection to a storage medium command bus from a format in accordance with said one of the ATA/IDE standard or the Serial ATA standard into a format in accordance with said one of the IEEE 1394 standard or the Universal Serial Bus standard, and to supply the converted commands to the terminals for connection to the external databus.

The present invention is applicable to any type of host apparatus including, but not exclusively, a digital television receiver apparatus, a personal computer, a camera, a video recorder or a personal digital assistant.

The storage medium device standard may be one of the ATA/IDE standard or the Serial ATA standard. ATA stands for Advanced Technology Attachment. IDE stands for Integrated Drive Electronics.

The ATA/IDE standard is a standard which has been developed by the TB working ground of NCITS (National Committee on Information Technology Standards). Sometimes this standard is referred to as ATA or IDE by themselves and sometimes this standard is referred to as parallel ATA. This standard is evolving to increase performance. Future evolutions may be used in the present invention.

The Serial ATA standard was developed by a working group of companies. It is evolving and has various specifications, such as Serial ATA 1.0 and Serial ATA II. Serial ATA 1.0 was developed by the Serial ATA Working Group. When the specification was published, the group included Dell, Intel, Maxtor, Seagate, and APT Technologies. This working group disbanded after publishing the specification. A follow-up industry group, the Serial ATA II Working Group, was formed to develop the extensions to the 1.0 specification. These extensions are normally referred to as Serial ATA II. Membership of the Serial ATA II Working Group is essentially the same group of companies, which includes Dell, Intel, Maxtor, Seagate, and Vitesse (which acquired APT Technologies). Future evolutions of Serial ATA may be used in the present invention.

Therefore, the one of the ATA/IDE standard or the Serial ATA standard employed in the present invention may be referred to by various acronymous, including ATA, IDE, ATA/IDE, S-ATA, ATA/ATAPI, EIDE, ATA-2, Fast ATA, ATA-3, Ultra ATA or Ultra DMA among others.

As an alternative to the ATA/IDE standard and the Serial ATA standard, the present invention could use any other storage medium device standard for transmitting commands to a storage medium device over a command bus.

Similarly the external storage medium device may be of any type, including, but not exclusively, a disk drive having a fixed storage medium or a device capable of reproduction of a removable storage medium, for example a removable semiconductor memory such as a flash memory, an magnetic medium such as a floppy disc, an optical medium such as a CD or DVD or a magneto-optical medium.

The external databus may be arranged in accordance with the IEEE 1394 standard including a suitable storage-oriented protocol such as the Serial Bus Protocol (SBP) eg SBP-2 or SBP-3, or in accordance with the Universal Serial Bus (USB) standard including a suitable storage-oriented protocol such as the Bulk Only Mass Storage Protocol. The external databus may alternatively be some other type of serial bus, or in general in accordance with any standard for a databus for localised connection of nodes, eg within a single premise.

An embodiment of the present invention will now be described by way of non-limitative example with reference to the accompanying drawings, in which:

FIG. 1 is a functional block diagram of a host apparatus connected to an external storage medium device over an external databus using an interface for the external databus implemented on the host apparatus; and

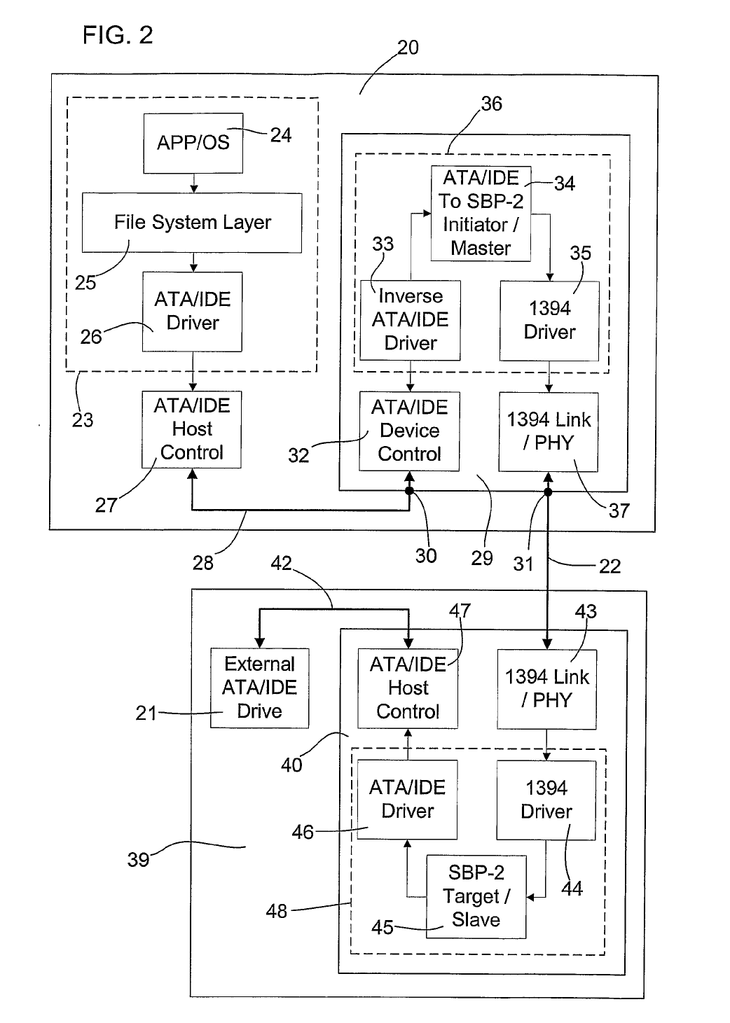

FIG. 2 is a functional block diagram of a host apparatus connected to an external storage medium device over an external databus in accordance with the present invention.

FIG. 2 shows an embodiment of the present invention which provides a host apparatus 20 with the capability of transmitting commands to an external storage medium device 21, in order to store data on, and retrieve data from, the external storage medium device 21, over an external databus 22 arranged in accordance with the IEEE 1394 standard using the SBP-2 protocol. The host apparatus 22 maybe an apparatus of any type, for example a digital television receiver apparatus.

In this embodiment, the storage medium device standard for transmitting commands to the external storage medium device 21 is the ATA/IDE standard. In accordance with the ATA/IDE standard, the commands may include commands to record data on a storage medium and commands to reproduce data from a storage medium. Subsequent to the commands being transferred, a data transfer occurs either to the external storage medium device 21 from the host apparatus 22 or from the external storage medium device 21 to the host apparatus 22. Subsequent to the data transfer, a status is passed back from the external storage medium device 21 to the host apparatus 22, although this description will focus on the transmitted commands for clarity.

The external storage medium device 21 may be of any type and includes software stacks and hardware for recording data to, and reproducing data from, a recording medium which may be fixed or removable.

The host apparatus 22 has a PC or MAC arrangement using software which is executable on a processor 23, as follows.

An application/operating system layer 24 consists of application programs running on the host platform which use and produce data which is stored on, or retrieved from, the external storage medium device 21. The application/operating system layer 24 interfaces to a file system layer 25 by requesting storage or retrieval of files containing data.

The file system layer 25 understands the type, characteristics and format of the storage media and maintains/manages the structure and integrity of the files stored and read by the external storage medium device 21. The file system layer 25 includes a SCSI command set layer. The file system layer 25 may interfaces to SBP-2 or ATA/IDE through the use of simple identify/read/write commands. The file system layer 25 can supply such commands to a command interface consisting of an ATA/IDE driver layer 26 and, below that, ATA/IDE host control logic 27, for transmitting the commands over a ATA/IDE bus 28 which serves as the command bus.

The ATA/IDE driver layer 26 manages the actual hardware involved in connection in accordance with the ATA/IDE standard to a storage medium device in accordance with the ATA/IDE standard. The ATA/IDE driver layer 26 provides services for management, read and writing over the specific hardware.

The host apparatus 20 has ATA/IDE host control logic 27 is the host-side physical connection to the external storage medium device 21. The ATA/IDE host control logic 27 is connected to the ATA/IDE bus 28.

The arrangement of the ATA/IDE driver layer 26 and the ATA/IDE host control logic is in accordance with the ATA/IDE standard, as though a storage medium device was connected directly to the ATA/IDE bus 28, but this is not in fact the case.

The host apparatus 20 further includes an integrated circuit chip 29 connected between the ATA/IDE bus 28 and the external databus 22, and having an interface which converts commands received from the ATA/IDE bus 28 in a format in accordance with the ATA/IDE standard into a format in accordance with the IEEE 1394 standard and transmits the commands onto the external databus 22.

The application/operating system layer 24, the file system layer 25, the ATA/IDE driver layer 26 and the ATA/IDE host control logic 27 of the host apparatus 20 are substantially the same as the application/operating system layer 5, the file system layer 6, the ATA/IDE driver layer 7 and the ATA/IDE host control logic 8 of the host apparatus 1 shown in FIG. 1. Thus, the integrated circuit chip 29 may be provided as a direct replacement for the internal disk drive 2 of the host apparatus 1 shown in FIG. 1.

The integrated circuit chip 29 may be mounted on a small PCB with an ATA/IDE connector at one end and a IEEE1394 connector at the other. The integrated circuit chip 29 will only need a source of power, which could optionally power the external storage medium device 21 via the external databus 22.

The integrated circuit chip 29 is arranged as follows. The integrated circuit chip 29 has terminals 30 connected to the ATA/IDE bus 28 and terminals 31 connected to the external databus 22.

Connected to receive commands from the terminals 30 is ATA/IDE device control logic 32 which the device-side physical connection to the ATA/IDE host and which supplies the commands to an inverse ATA/IDE driver layer 33. The inverse ATA/IDE driver layer 33 is a layer in accordance with the ATA/IDE standard for receiving commands from the ATA/IDE bus 28. In particular, the inverse ATA/IDE driver layer 33 manages the ATA/IDE device control logic 32 involved in the device connection to the ATA/IDE bus 28, and also provides services for reception of commands, and transfers of data/status over the ATA/IDE bus 28. The inverse ATA/IDE driver layer 33 supplies the received commands to an ATA/IDE to an SBP-2 Initiator/Master Bridge 34.

The SBP-2 Initiator/Master Bridge 34 is a layer for converting the received commands into a format in accordance with the IEEE 1394 standard including the SBP-2 protocol. SBP-2 is a protocol for passing ATA/IDE interface commands and data across a databus in accordance with the 1394 standard. In particular, the ATA/IDE to SBP-2 Initiator/Master Bridge 34 translates the commands received from the inverse ATA/IDE driver layer 33 into structures and commands capable of SBP-2 transport, and also controls the translation of data passing to and from the external storage medium device 21 between the ATA/IDE format and the IEEE 1394 format. The SBP-2 Initiator/Master Bridge 34 supplies the converted commands to a 1394 driver layer 35.

The inverse ATA/IDE driver layer 33, the SBP-2 Initiator/Master Bridge 34 and the 1394 driver layer 35 are implemented in software executable on a processor 36.

The 1394 driver layer 35 is a layer arranged in accordance with the IEEE 1394 standard to transmit the converted commands over the external databus 22. In particular, the 1394 driver layer 35 manages the 1394 link layer/physical layer 37 which is the actual hardware involved in the external databus 22. The 1394 driver layer 35 provides services for management, transmission and reception of 1394 packets over the external databus 22.

The 1394 link layer/physical layer 37 provides the ability to manage, transmit and receive data across the external databus 22 via the terminals 31. One possible implementation for the 1394 link layer/physical layer 37 is an OHCl chip.

The integrated circuit chip 29 may optionally have other functions in addition to the conversion of received commands from a format in accordance with the ATA/IDE standard into a format in accordance with the IEEE 1394 standard. For example, the integrated circuit chip 29 may control streaming of data in accordance with the IEEE 1394 standard over the external databus 22 to devices other than the external storage medium device 21. This function may make common use of the 1394 driver layer 35 and the 1394 link layer/physical layer 37.

The external storage medium device 21 is arranged in a target apparatus 39 having a bridge circuit 40 which has an interface for converting commands received from the host apparatus 20 via the external databus 22 from a format in accordance with the IEEE 1394 standard into a format in accordance with the ATA/IDE standard for supply to the external storage medium device 21 over an ATA/IDE bus 42. Thus the bridge circuit 40 performs the inverse function from the integrated circuit chip 29 which converts commands received in a format in accordance with the ATA/IDE standard into a format in accordance with the IEEE 1394 standard. The bridge circuit 40 is identical to the bridge circuit 13 in the arrangement shown in FIG. 1 and in particular the interface of the bridge circuit 41 is constituted by the following layers.

The interface 40 has a 1394 link layer/physical layer 43 which is connected to the external databus and provides the ability to manage, transmit and receive data across the external databus 22. One possible implementation for the 1394 link layer / physical layer 43 is an OHCl chip. The 1394 link layer/physical layer 43 receives commands from the external databus 22 and supplies them to a 1394 driver layer 44.

The 1394 driver layer 44 is a layer arranged in accordance with the IEEE 1394 standard to receive the commands from the external databus 22. In particular, the 1394 driver layer 44 manages the 1394 link layer/physical layer 43, and also provides services for management, transmission and reception of 1394 packets over the external databus 22. The 1394 driver layer supplies received commands to an SBP-2 target/slave layer 45.

The SBP-2 target/slave layer 45 manages the external storage medium device 21 as an SBP-2 remote storage medium. The SBP-2 target/slave layer 45 converts the received commands which are in a format in accordance with the IEEE 1394 standard including the SBP-2 protocol into a format in accordance with the ATA/IDE standard, and uses these to drive an ATA/IDE driver layer 46 for management storage and retrieval, thus maintaining compatibility with the SBP-2 protocol implemented in the SBP-2 Initiator/Master Bridge 34 of the integrated circuit chip 29.

The ATA/IDE driver layer 46 is a layer in accordance with the ATA/IDE standard for supplying commands to the ATA/IDE bus 42. In particular, the ATA/IDE driver layer 46 manages ATA/IDE device control logic 47 involved in the device connection to the ATA/IDE bus 42 which is the physical connection to the ATA/IDE bus 42.

The ATA/IDE driver layer 44, the SBP-2 target/slave layer 45 and the ATA/IDE driver layer 46 are implemented in software executable on a processor 48.

To summarise the above, the effect of the integrated circuit chip 29 is to convert the format ATA/IDE bus commands and data to IEEE1394 SBP-2, and to act as a host device to send these over the external databus to the remotely connected bridge circuit 40 and thus to the external storage medium device 21. The external storage medium device 21 behaves as if it were local to the ATA/IDE driver layer of the host apparatus 20, even though it is not.

As the integrated circuit chip 29 encapsulates all of the required protocols and hardware, the capability of sending commands to the external storage medium device 21 may be achieved simply by adding the integrated circuit chip to an existing design for the host apparatus 20 with only a minimal change to that the design with regard to aspects of remote disk login and to handle the notion of removable storage media.

For example, file systems in the file systems layer 25 will take account of the possibility of the external storage medium device 21 acting as a removable storage media, in contrast to an internal disk drive which typically does not have this functionality.

As the integrated circuit chip 29 takes advantage of the ATA/IDE interface already present and contains all the software and hardware functionality to bridge transactions from the ATA/IDE bus 28 to the external databus 22, it is not necessary for the host apparatus to implement the interface to the external databus 22 as in the implementation shown in FIG. 1. Thus, the additional burden on the processor 23 of the host apparatus 20 is very low and there is no issue of extra utilisation of the processor 23 limiting performance.

The use of an external databus 22 in accordance with the IEEE 1394 standard has the advantages of a small IEEE1394 bus connector and of allowing the external storage medium device 21 to be of any type compatible with the IEEE 1394 standard.

1. A method of arranging a host apparatus to transmit commands to an external storage medium device connected to the host apparatus over an external databus which is arranged in accordance with one of the IEEE 1394 standard or the Universal Serial Bus standard, the method comprising: providing the host apparatus with a command bus and a command interface arranged in accordance with one of the ATA/IDE standard or the Serial ATA standard for transmitting commands to a storage medium device over the command bus; and providing the host apparatus with at least one integrated circuit chip connected to the command bus and to the external databus and having an interface arranged to convert commands received from the command bus in a format in accordance with said one of the ATA/IDE standard or the Serial ATA standard into a format in accordance with said one of the IEEE 1394 standard or the Universal Serial Bus standard and to transmit the converted commands over the external databus.

2. A method according to claim 1, wherein the host apparatus is a digital television receiver apparatus.

3. A method according to claim 1, wherein one of the ATA/IDE standard or the Serial ATA standard is the ATA/IDE standard.

4. A method according to any one of the preceding claims claim 1, wherein said one of the IEEE 1394 standard and the Universal Serial Bus standard is the IEEE 1394 standard.

5. A method according to claim 4, wherein said one of the IEEE 1394 standard and the Universal Serial Bus standard is the IEEE 1394 standard including a Serial Bus Protocol.

6. A method according to claim 1, wherein the interface of the integrated circuit chip comprises: a first layer arranged in accordance with said storage medium device standard to receive commands from the command bus; a second layer arranged to convert commands output from the first layer into a format in accordance with said one of the IEEE 1394 standard or the Universal Serial Bus standard; and a third layer arranged in accordance with said one of the IEEE 1394 standard or the Universal Serial Bus standard to transmit the converted commands over the external databus.

7. A host apparatus arranged to transmit commands to an external storage medium device connected to the host apparatus over an external databus which is arranged in accordance with one of the IEEE 1394 standard or the Universal Serial Bus standard, the host apparatus comprising: a command bus and a command interface arranged in accordance with one of the ATA/IDE standard or the Serial ATA standard for transmitting commands to a storage medium device over the storage medium command bus; and at least one integrated circuit chip connected to the storage medium command bus and having terminals for connection to the external databus, the integrated circuit chip having an interface arranged to convert commands received from the command bus in a format in accordance with one of the ATA/DDE standard or the Serial ATA standard into a format in accordance with said one of the IEEE 1394 standard or the Universal Serial Bus standard, and to supply the converted commands to the terminals for connection to the external databus.

8. A host apparatus according to claim 7, wherein the host apparatus is a digital television receiver apparatus.

9. A host apparatus according to claim 7, wherein said one of the ATA/DDE standard or the Serial ATA standard is the ATA/IDE standard.

10. A host apparatus according to claim 7, wherein said one of the IEEE 1394 standard and the Universal Serial Bus standard is the IEEE 1394 standard.

11. A host apparatus according to claim 10, wherein said one of the IEEE 1394 standard and the Universal Serial Bus standard is the IEEE 1394 standard including a Serial Bus Protocol.

12. A host apparatus according to claim 7, wherein the interface of the integrated circuit chip comprises: a first layer arranged in accordance with said one of the ATA/IDE standard or the Serial ATA standard to receive commands from the command bus; a second layer arranged to convert commands output from the first layer into a format in accordance with said one of the IEEE 1394 standard or the Universal Serial Bus standard; and a third layer arranged in accordance with said one of the IEEE 1394 standard or the Universal Serial Bus standard to transmit the converted commands over the external databus.

13. An integrated circuit chip having: terminals for connection to a command bus in accordance with one of the ATA/IDE standard or the Serial ATA standard for transmitting commands to a storage medium device over the storage medium command bus; terminals for connection to an external databus in accordance with one of the IEEE 1394 standard or the Universal Serial Bus standard; and an interface arranged to convert commands received at the terminals for connection to a storage medium command bus from a format in accordance with one of the ATA/IDE standard or the Serial ATA standard into a format in accordance with said one of the IEEE 1394 standard or the Universal Serial Bus standard, and to supply the converted commands to the terminals for connection to the external databus.

14. An integrated circuit chip according to claim 13, wherein the host apparatus is a digital television receiver apparatus.

15. An integrated circuit chip according to claim 13, wherein one of the ATA/IDE standard or the Serial ATA standard is the ATA/IDE standard.

16. An integrated circuit chip according to claim 13, wherein said one of the IEEE 1394 standard and the Universal Serial Bus standard is the IEEE 1394 standard.

17. An integrated circuit chip according to claim 16, wherein said one of the IEEE 1394 standard and the Universal Serial Bus standard is the IEEE 1394 standard including a Serial Bus Protocol.

18. An integrated circuit chip according to claim 13, wherein the interface of the integrated circuit chip comprises: a first layer arranged in accordance with one of the ATA/DDE standard or the Serial ATA standard to receive commands from the command bus; a second layer arranged to convert commands output from the first layer into a format in accordance with said one of the IEEE 1394standard or the Universal Serial Bus standard; and a third layer arranged in accordance with said one of the IEEE 1394 standard or the Universal Serial Bus standard to transmit the converted commands over the external databus.
